(19) United States
(12) Patent Application Publication
(10) Pub. No.: US 2008/0093167 A1
(43) Pub. Date: Apr. 24, 2008

(54) Nestable step

(75) Inventors: Craig M. Saunders, Rocky River, OH (US); Lindsey Tufts, Eastlake, OH (US); Jeffrey M. Kalman, Cleveland Heights, OH (US)

Correspondence Address: FAY SHARPE LLP, 1100 SUPERIOR AVENUE, SEVENTH FLOOR, CLEVELAND, OH, 44114, US

(73) Assignee: J.F. Meskill Enterprises, LLC

(21) Appl. No.: 11/584,826

(22) Filed: Oct. 23, 2006

(51) Int. Cl. E06C 7/16

(52) U.S. Cl. 182/33; 182/222

(57) ABSTRACT

A step stool nestable for stacking is formed vertically tapered with the smaller end closed to form a horizontal stepping surface. The interior of the shell has attachment surfaces faces upon which the casters are attached for use.

Initially the casters are mounted on the undersurface of the closed end to permit stacking of the stools for bulk transport or shipment in quantities. Upon separating the stools in the stack, the user removes the platform and casters from the undersurface of the closed end and attaches them to attachment surfaces in the shell. In the disclosed embodiment a platform member is attached to the shell and the casters mounted on the platform member. In the disclosed embodiment, the casters and platform member are enclosed in a container and releasably secured to the undersurface of the closed end of the shell for stacking.

### BACKGROUND

The present disclosure relates to portable step stools and particularly to step stools of the type employing spring loaded casters enabling the step stool to be easily rolled about the surface upon which the user is standing; and, upon the user placing a foot upon the stepstool, the stool is lowered to the floor or surface and rests thereon such that the casters are rendered inoperative and the stool is safely registered firmly on the supporting surface or floor.

Stools of this type are well known and may have a single step or two step configuration with the single or upper step having a smaller dimension than the lower step or base giving a slightly tapered appearance to the step stool.

In view of the tapered configuration of such portable step stools and further in view of their generally lightweight construction for portability, it has been desired to minimize the volume of the packaged step stools for transport or shipment from the factory and particularly where it is desired to ship a large quantity of such step stools to a distant or remote destination where shipping costs are significant. Where such step stools are packaged individually in a carton, the shipment of a large quantity of the step stools from the factory requires a substantial volume of space in the cargo compartment of the vessel or vehicle in which the step stools are to be transported or shipped.

Because of the presence of the casters, it has not been feasible to stack the step stools-in any way that would significantly reduce the volume of the step stools in large quantities for bulk shipment. If the stepstools are shipped without the casters, it then becomes necessary to package a set of casters separately for each stool and provide a way of including the casters along with the stools. If several of the stools without casters attached were nested for bulk shipment, then extra packages of casters were required to accompany the step stools which has complicated bulk transport or shipment. Accordingly, it has long been desired to provide a way or means of nesting such step stools for compact bulk shipment and yet conveniently include the requisite casters with each individual stool.

### SUMMARY

The present disclosure describes a step stool having a tapered configuration for nestably stacking to facilitate bulk transport or shipment in quantities, yet each individual step stool has its own set of casters packaged therewith on the interior thereof attached to the underside of the step surface. This arrangement enables nesting of several step stools in a stack with reduced volume for bulk transport or shipment. Upon reaching the market destination, the step stools may be separated from the stack without the necessity of handling the casters and any hardware associated therewith. This feature facilitates subsequent individual packaging, if any is desired.

The step stool of the present disclosure has the casters and a platform member employed for mounting the casters disposed in a container or carton which is removably attached to the underside of the step surface which location does not impede nesting of the step stools in a stack. The carton with the casters and associated hardware therein is attached to the underside of the step surface conveniently in any convenient user removable manner such as, for example, by using adhesive taping. The tapered shell of the presently disclosed step stool may have a rectangular configuration in cross-section to maximize the peripheral area of the shell edge registered against the surface upon which the step stool is being used. In the disclosed embodiment, the shell and closed end forming the step surface are integrally formed as a one-piece member; and, if desired, stiffening ribs may also be integrally formed in the underside of the closed end of the shell forming the stepping surface.

### BRIEF DESCRIPTION OF THE DRAWINGS

FIG. 1 is a perspective view of the shell of the present step stool;

FIG. 2 is a section view taken along section indicating lines 2-2 of FIG. 1 and includes a plurality of the stools stacked in nested configurations;

FIG. 3 is a perspective view showing a platform member and caster wheel employed in the disclosed embodiment;

FIG. 4 is a perspective view of the caster and platform hardware received in a container prior to attachment to the step stool shell; and,

FIG. 5 is a view from the underside or open end of the step stool of the present disclosure in its assembled state ready for usage.

### DETAILED DESCRIPTION

Referring to the drawings, the assembled step stool of the present disclosure is indicated generally at 10 in FIG. 5 ready for use. Stool 10 includes a shell member 12 and a plurality of casters indicated generally at 26.

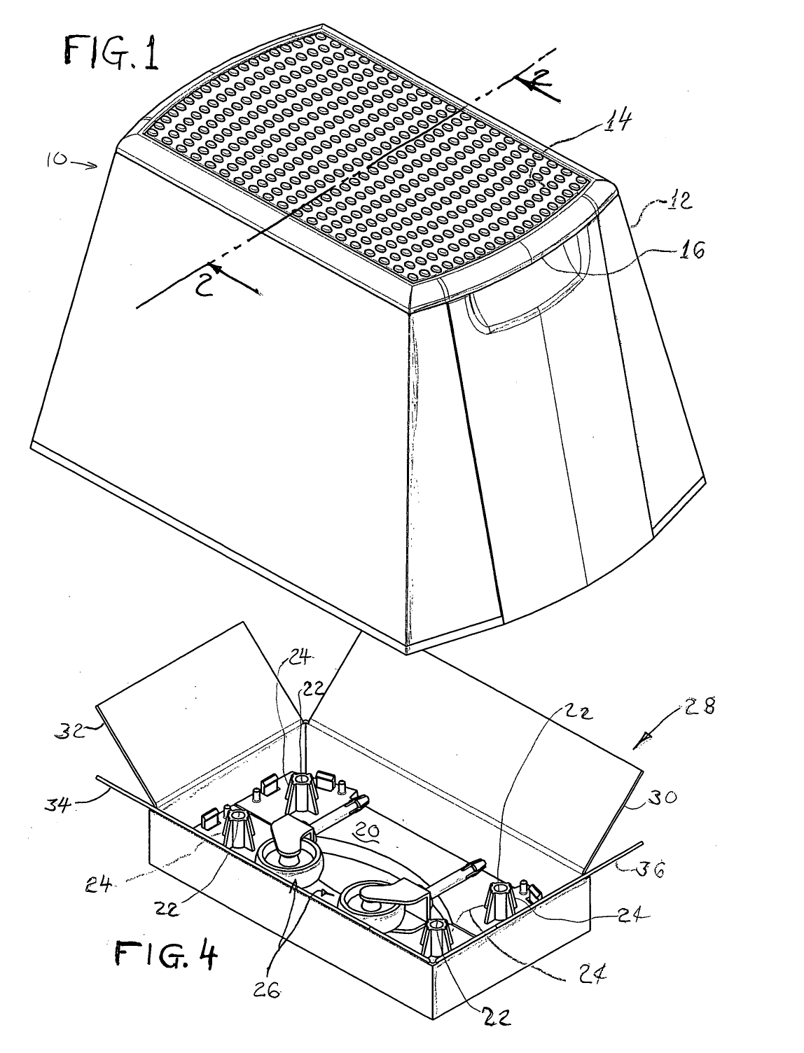

Referring to FIG. 1, shell 12 has a generally inverted cup shaped configuration with the vertically upper end closed and the lower end open to form a rim for the shell. A user step surface 14 is formed on the exterior of the closed end; and, if desired, the step surface may have anti-slip or gripping surfaces formed thereon to minimize the risk of the user's foot slipping off on the step stool. Although the shell 12 may have any convenient or desired configuration, the embodiment illustrated and described in the present disclosure has a generally vertically tapered configuration, rectangular in cross-section and thus having a general shape similar to that of a cow bell.

Alternatively, the shell 12 may have other configurations such as, for example, round, oval, polygonal, elliptical, square or triangular.

In the presently disclosed embodiment, the shell 12 has a relatively thin wall with respect to the transverse dimension thereof; and, therefore suitable reinforcing ribs 13 may be provided on the undersurface of the closed end. If desired, the ribs 13 and shell 12 may be formed integrally as a one piece member.

In order to facilitate user handling of the assembled step stool, gripping surfaces may be provided in the region of the closed or upper end; and, in the illustrated and disclosed embodiment described herein, at least one such surface in the form of a recess 16 may be provided adjacent the edge of the step surface as denoted by reference numeral 16.

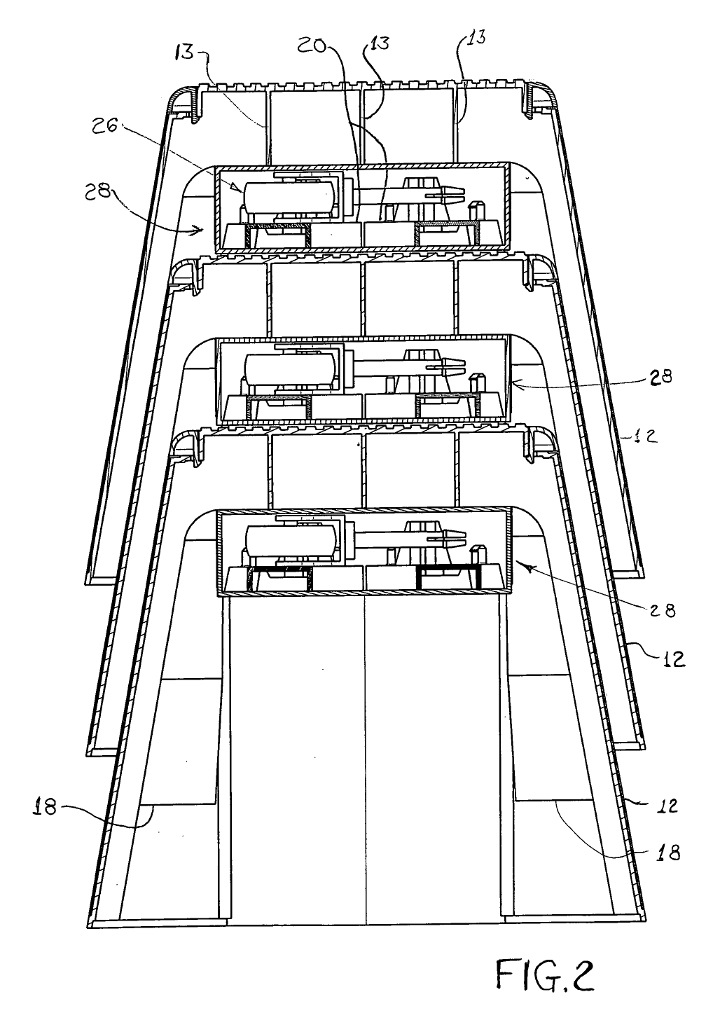

Referring to FIG. 2, the step stool shell 12 has provided on the interior thereof attachment or registration surfaces 18 which are configured to have registered there against and retained thereon by any suitable expedient, as, for example, by friction, snap locking surfaces or detents (not shown) a platform member 20 configured to closely interfit the interior wall of the shell 12. In the illustrated embodiment, a pair of platform members 20 are employed, each provided for mounting a pair of casters 26 thereon.

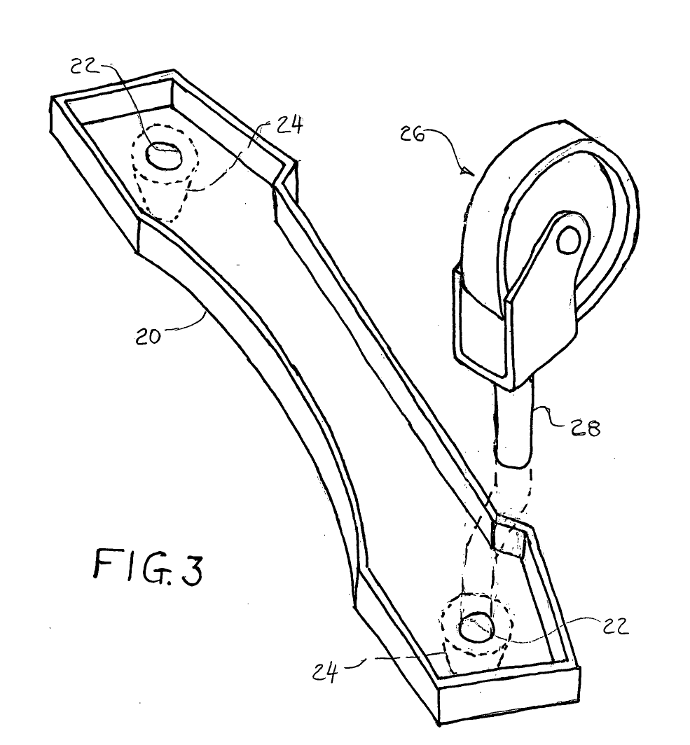

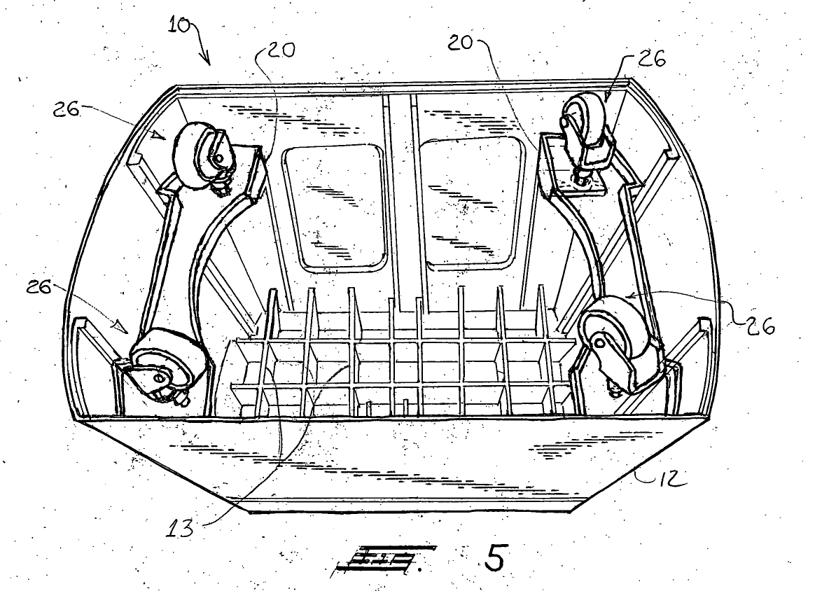

Referring to FIG. 3, one of the platform members 20 is illustrated and includes spaced apertures 22 formed in the end regions thereof, which apertures are adapted for receiving a mounting post of a caster therein. A typical caster 26 is shown generally at 26 in FIG. 3 and includes a mounting post 28 which is received in the aperture 22 in the platform upon assembly of the platform into the shell 12 as illustrated in FIG. 5. If desired, reinforcing towers 24 may be provided on the platform member 20 with the apertures 22 formed therein as indicated in dashed outline in FIG. 3 and solid outline in FIG. 4 for providing rigidity to the mounting of the caster.

It is contemplated that the caster mounting posts 28 may be received in the apertures in spring loaded sliding arrangement and retained therein to prevent the posts from dropping out when the stool is raised. As is known, the caster posts 28 may have springs disposed thereover (not shown) for biasing the casters outwardly of shell 12 to permit user rolling of the step stool.

It will be understood however that the attachment surfaces 18 formed in the interior of the shell for the platform member 20 may in the alternative, include suitable apertures for receiving the posts 28 of the caster directly thereby eliminating the platform member 20. However, such an arrangement requires that the mounting surfaces extend inwardly to a greater extent than the wall of the shell in the disclosed embodiment which will have the effect of increasing somewhat the stack height of the step stools. Nevertheless, such alternative arrangement is contemplated within the scope of the appended claims.

Referring to FIGS. 2 and 4, a container indicated generally at 28 is illustrated in the disclosed embodiment as a carton having foldable cover flaps 30, 32, 34, 36 for effecting closure of the container. As shown in FIG. 4, a set of caster hardware is provided and disposed within the container in a generally nested arrangement. In the illustration of FIG. 4, both of the platform members 20 and one pair of the caster wheels 26 are shown disposed in the container; however, it will be understood that the second pair of caster wheels may be nested thereover, but have been omitted from the drawing for the sake of clarity.

The container with the platform members and caster wheels therein is then closed and releasably attached to the undersurface of the closed end of the shell as shown in FIG. 2 and retained thereon by any suitable expedient such as, for example, adhesive tape, snap locking tabs, or detents (not shown).

The arrangement of the shell with the caster wheel mounting hardware attached in container 28 thus enables a plurality of the step stools to be stacked in a nested configuration as shown in FIG. 2 for bulk transport or shipment. Upon arrival at the destination or market the individual step stools are separated from the stack and may then be used or sold individually. In preparation for use, the container is removed from the underside of the closed end, the caster wheel hardware removed from the container and the caster hardware assembled onto the shell to provide the configuration shown in FIG. 5.

The step stool of the present disclosure thus permits stacking in a nested configuration with the complete caster wheel hardware for each individual step stool attached thereto yet provides an arrangement which substantially reduces the volume of the container required for bulk transport or shipment of a plurality of the step stools.

If the step stools 10 are to be sold as individual consumer products, they may be packaged in individual plastic bags. The bags can be printed with distributor information, assembly instructions, UPC markings and still retain substantial transparent areas, allowing a consumer to view the product. The bags are sized to follow the interior and exterior contours of the step stool 10, allowing nesting in the packaged state. The bags not only provide the finished package, but also protect the surfaces of the step stool during shipment. Alternatively, the step stools may be sold with plastic sheets lightly adhered to the outer steel surfaces. The plastic sheets carry distributor information and UPC markings. The plastic sheets protect the exterior surface of the step stool 10 during shipment and are removable by the consumer.

Although the step stool of the present disclosure has herein above been described with respect to the illustrated embodiments, it will be understood that modification, variations and other embodiments may be made within the scope of the following claims.

1. A step stool of the type nestable for stacking comprising:
a) a shell having an open end and a closed end including a horizontally disposed step surface disposed on said closed end, the shell having attachment surfaces provided on the interior thereof proximate the open end;
b) a rigid platform member configured to interfit the shell and engage said attachment surfaces;
c) at least one caster removably disposed on said platform member; and
d) a container with said platform member and said at least one caster disposed therein, said container removably attached to the undersurface of said step surface, wherein a plurality of said stools each with said container attached are nestable for stacking.

2. The step stool defined in claim 1, wherein said shell has a generally rectangular confirmation in cross section.

3. The step stool defined in claim 1, wherein said at least one platform member comprises a pair of spaced oppositely disposed platform members.

4. The step stool defined in claim 1, wherein said at least one platform member comprises a pair of spaced oppositely disposed members each operable for having a pair of said castors disposed thereon.

5. The step stool defined in claim 1, wherein said attachment surfaces include surfaces operable for snap-locking engagement with said at least one platform member.

6. The step stool defined in claim 1, wherein said at least one caster includes a post member operable for sliding engagement with said at least one platform member.

7. The step stool defined in claim 1, wherein said container is taped to the undersurface of said step surface.

8. The step stool defined in claim 1, wherein said shell has at least one gripping surface formed thereon for facilitating lifting by the user.

9. The step stool defined in claim 1, wherein said step surface includes anti-slip surfaces formed thereon.

10. The step stool defined in claim 1, wherein said shell includes stiffening ribs on the underside of said step surface.

11. The step stool defined in claim 10, wherein said shell step surface and ribs are integrally formed as a one piece member.

12. The step stool defined in claim 1, wherein said container when attached is registered against said ribs.

13. The step stool defined in claim 1, wherein said shell has a tapered configuration.

14. A method of making a stackable step stool comprising:
a) forming a shell member having an inverted cup shaped configuration with a closed end and an open rim;
b) forming a step surface on the closed end of said shell member;
c) forming attachment surfaces on the interior of the shell member in the region of the rim of said cup shape;
d) forming a platform member configured to interfit with said shell member and contact said attachment surfaces;
e) providing a caster and configuring said platform member for mounting the caster thereon; and
f) disposing the caster and platform member on the under side of said closed end for and subsequent user removal thereby facilitating nestable stacking of a plurality of said step stools.

15. The method defined in claim 14, wherein the step of disposing the caster and platform includes disposing same in a user removable container.

16. The method defined in claim 14, wherein the step of forming attachment surfaces includes forming surfaces operable for snap-locking engagement with the platform.

17. The method defined in claim 14, wherein the step of configuring the platform includes forming surfaces thereon operable for retaining the caster.

18. The method defined in claim 14, wherein the step of forming the smaller end of the shell closed and forming a step surface includes forming a one-piece member.

19. The method defined in claim 14, wherein the step of forming the smaller end closed includes the step of forming stiffening ribs on the interior side thereof.

20. The method defined in claim 19, wherein the step of forming ribs includes integrally forming the ribs and closed end integrally as one piece.

21. The method defined in claim 14, wherein the step of forming a shell includes forming a shell having a generally rectangular shape in cross section.

22. A method of making a step stool nestably stackable comprising:
a) forming a shell with a closed end and an open end distal said closed end;
b) forming attachment surfaces on the interior of the shell in the region of the open end for user attachment of casters thereto;
c) forming a user step on the outer surface of the closed end; and
d) removably mounting casters on the inner surface of the closed end and forming an arrangement permitting nestable stacking of a plurality of the step stools.

23. The method defined in claim 22, wherein the step of forming attachment surfaces on the interior of the shell includes the step of providing a platform member attachable to the attachment surfaces and mounting the casters on the platform member.

24. The method defined in claim 22 wherein the step of removably mounting casters includes removably mounting the platform.

25. The method defined in claim 22, wherein the step of forming a shell includes forming a vertically tapered configuration with said closed end smaller than the open end.

26. The method defined in claim 22, wherein the step of forming a shell includes the step of forming a shell having the wall thereof relatively thin with respect to the transverse dimension of the open end.

27. The method defined in claim 22, wherein the step of forming a shell includes forming a shell having a cow bell configuration.

28. The method defined in claim 22, wherein the step of forming a shell includes forming a shell having a generally rectangular configuration.

29. The method defined in claim 22, wherein the step of forming a shell includes the step of forming a gripping surface proximate said closed end.
